(19) United States
(12) Patent Application Publication
(10) Pub. No.: US 2006/0129729 A1
(43) Pub. Date: Jun. 15, 2006

(54) Local bus architecture for video codec

(76) Inventors: Hongjun Yuan, San Jose, CA (US); Shuhua Xiang, Fremont, CA (US); Li-Sha Alpha, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/187,359

(22) Filed: Jul. 21, 2005

Related U.S. Application Data
(60) Provisional application No. 60/635,114, filed on Dec. 10, 2004.

(51) Int. Cl. G06F 13/14

(52) U.S. Cl. 710/240

(57) ABSTRACT

A novel architecture for implementing video processing features a data bus and a control bus. In an embodiment, data transfers between processing modules can take place over the data bus as mediated by a programmable memory copy controller, or through local connections, freeing up the control bus for instructions provided by a processor. A video decoder may be implemented in a system on chip with instructions provided by an off-chip processor. A semaphore or semaphore array mechanism may be used to mediate traffic between the various modules.

### CROSS REFERENCE TO RELATED APPLICATIONS

This application claims the benefit of U.S. Provisional Application No. 60/635,114, filed on Dec. 10, 2004, which is herein incorporated in its entirety by reference.

### BACKGROUND

1. Field of Invention

This invention relates generally to the field of chip design, and in particular, to microchip bus architectures that support video processing.

2. Background of Invention

Video processing is computationally intensive. Encoder and decoder systems that conform to one or more compression standards such as MPEG4 or H.264 typically include a variety of hardware and firmware modules to efficiently accomplish video encoding and decoding. These modules exchange data in the course of performing numerous calculations in order to carry out motion estimation and compensation, quantization, and related computations.

In traditional bus protocols, a single arbiter controls communication between one or more masters and slaves and a common bus is used for the transmission of data and control signals. This protocol is suited to device-based systems, for instance that rely on system on chip (SOC) architectures. However, this architecture is not optimal for video processing systems, because only one master can access the system bus at a time, producing a bandwidth bottleneck. Such bus contention problems are particularly problematic for video processing systems that have multiple masters and require rapid data flow between masters and slaves to in accordance with video processing protocols.

What is needed is a way to integrate various processing modules in a video processing system in order to enhance system performance.

### SUMMARY OF THE INVENTION

Embodiments of the present invention provide a novel architecture for video processing in a multi-media system that overcomes the problems of the prior art. In an embodiment, a video processing system is recited that comprises a plurality of processing modules including a first processing module and a second processing module. A data bus couples the first processing module and second processing module to a copy controller, the copy controller configured to facilitate the transfer of data between the first processing module and the second processing module over the data bus. A control bus couples a processor and a processing module together and is configured to provide control signals from the processor to the processing module of the plurality of processing modules. Because the various modules can exchange data through the data bus, the architecture more efficiently carries out transfer intensive processes such as video decoding or encoding.

In another embodiment, a method for decoding a video stream is disclosed. The video stream is received, and copied to a video processing module over a data bus. Instructions to process the stream are received over a control bus, and the stream is processed. The processed stream is provided to a memory over a local connection.

### BRIEF DESCRIPTION OF THE DRAWINGS

The accompanying drawings illustrate embodiments and further features of the invention and, together with the description, serve to explain the principles of the present invention.

FIG. 1 depicts a high-level block diagram of a video processing system in accordance with an embodiment of the invention.

FIG. 2 depicts a block diagram of an exemplary processing architecture for a decoder processing system in accordance with an embodiment of the invention.

FIG. 3 shows a process flow for decoding a video stream in accordance with an embodiment of the invention.

### DETAILED DESCRIPTION OF THE DRAWINGS

The present invention is now described more fully with reference to the accompanying Figures, in which several embodiments of the invention are shown. In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention. For example, the present invention will now be described in the context and with reference to MPEG compression, in particular MPEG 4. However, those skilled in the art will recognize that the principles of the present invention are applicable to various other compression methods, and blocks of various sizes. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and modules presented herein are not inherently related to any particular computer or other apparatus. Various general-purpose systems may be used with programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein. Furthermore, as will be apparent to one of ordinary skill in the relevant art, the modules, features, attributes, methodologies, and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific operating system or environment.

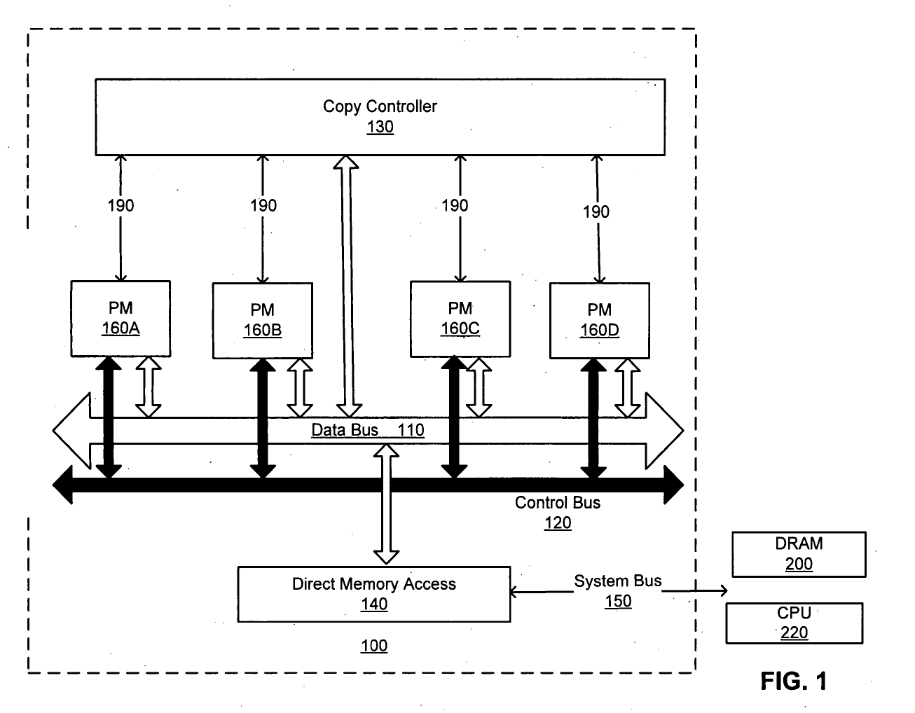

FIG. 1 depicts a high-level block diagram of a video processing system in accordance with an embodiment of the invention. The system 100 features a copy controller 130, several processing modules 160, and direct memory access (DMA) 140. Traffic within the system 100 alternately travels over a data bus 10 or a control bus 120. Data transferred between the various processing modules 160 is shared primarily by way of data bus 10, freeing up control bus 120 for transportation of command data. The processing system 100 can access DRAM 200 and CPU 220 by way of a system bus 150. As shown, the system 100 uses a generic architecture that can be implemented in any of a variety of ways—as part of a dedicated system on chip (SOC), general ASIC, or other microprocessor, for instance. The system 100 may also comprise the encoding or decoding subsystem of a larger multimedia device, and/or be integrated into the hardware system of a device for displaying, recording, rendering, storing, or processing audio, video, audio/video or other multimedia data. The system 100 may also be used in a non-media or other computation-intensive processing context.

The system has several advantages over typical bus architectures. In a peripheral component interconnect (PCI) architecture, a single bus is generally shared by several master and slave devices. Master devices initiate read and write commands that are provided over the bus to slave devices. Data and control requests, originating from the CPU 220, flow over the same common bus. In contrast, the system 100 shown has two buses—a control bus 120 and a data bus 110—to separate the two types of traffic, and a third system bus 150 to coordinate action outside of the system. A majority of copy tasks are controlled by the copy controller 130, freeing up CPU 220. Streams at various stages of processing can be temporarily stored to DMA 140. By allowing a large share of processing transactions to be carried out a specialized data bus 110 rather than having to rely on a shared system bus 150, the architecture mitigates bus contention issues, enhancing system performance.

The processing system 100 of FIG. 1 could be used in any of a variety of video or non-video contexts including a Very Large Scale Integration (VLSI) architecture that also includes a general processor and a DMA/memory. This or another architecture may include an encoder and/or decoder system that conforms to one or more video compression standards such as MPEG1, MPEG2, MPEG4, H.263, H.264, Microsoft WMV9, and Sony Digital Video (each of which is herein incorporated in its entirety by reference), including components and/or features described in the previously incorporated U.S. Application Ser. No. 60/635,114. This or another architecture may include an encoder or decoder system that conforms to one or more compression standards such as MPEG-4 or H. 264. A video, audio, or video/audio stream of any of a various conventional and emerging audio and video formats or compression schemes, including .mp3, .m4a., wav., .divx, .aiff, .wma, .shn, MPEG, Quicktime, RealVideo, or Flash, may be provided to the system 100, processed, and then output over the system bus 150 for further processing, transmission, or rendering. The data can be provided from any of variety of sources including a satellite or cable stream, or a storage medium such as a tape, DVD, disk, flash memory, or smart drive, CD-ROM, or other magnetic, optical, temporary computer, or semiconductor memory. The data may also be provided from one or more peripheral devices including microphones, video cameras, sensors, and other multimedia capture or playback devices. After processing is complete, the resulting data stream may be provided via system bus 150 to any of a variety of destinations.

Most data transfer between sub-blocks of the processing system 100 takes place through the data bus 110. In an embodiment, the data bus 110 is a switcher based 128-bit width data bus working at 133 MHz or the same frequency of a video CODEC. The copy controller 130 acts as the main master to the data bus 110. The copy controller 130, in one embodiment, comprises a programmable memory copy controller (PMCC). The copy controller 130 takes and fills various producer and consumer data requests from the assorted processing modules 160. Each data transfer has a producer, which puts the data into a data pool and a consumer, which obtains a copy of and uses the data in the pool. When the copy controller 130 has received coordinating producer and receiver requests, it copies the data from the producer to the consumer through the data bus, creating a virtual pipe.

In an embodiment, the copy controller 130 uses a semaphore mechanism to coordinate sub-blocks of the system 100 working together and control data transfer therebetween, for instance through a shared data pool (buffer, first in first out memory (FIFO), etc.). As known to one of skill in the art, semaphore values can be used to indicate the status of producer and consumer requests. In an embodiment, a producer module is only allowed to put data into a data pool if the status signal allows this action, likewise, a consumer is allowed to use data from the pool only when the correct status signal is given. Semaphore status and control signals are provided over local connections 190 between the copy controller 130 and individual processing modules 160. If the data pool is a FIFO, a semaphore unit resembles the flow controller for a virtual data pipe between a producer and consumer. However, in more complex cases, a producer may put data into a data pool in one form and the consumer may access data elements of another form from the data pool. If consumer is dependant on data produced by producer in these cases, a semaphore mechanism may be still used to co-ordinate the behaviors of producer and consumer. In this and other situations, the semaphore implements advanced coordination tasks as well as depending on the protocol between producer and consumer. A semaphore mechanism may be implemented through a semaphore array comprised of a stack of semaphore units. In an embodiment, each semaphore unit stores semaphore data. Both producers and consumers can modify this semaphore data and get the status of the semaphore unit (overflow/underflow) through producer and consumer interfaces. Each semaphore unit could be made available to the CPU 220 through the control bus 220.

The modules 160 carry out various processing functions. As used throughout this specification, the term “module” may refer to computer program logic for providing the specified functionality. A module can be implemented in hardware, firmware, and/or software. Preferably, a module is stored on a computer storage device, loaded into memory, and executed by a computer processor. Each processing module 160 has read/write interfaces for communicating with each other processing module 160. In an embodiment, the processing system 100 comprises a video processing system and the modules 160 each carry out various CODEC functions. To support these functions there are three types of modules 160—motion search/data prediction, miscellaneous data processing, and video processing modules.

As described above, most transfer of data between the modules 160 is carried over the data bus 110. Also included in the processing system 100 is a control bus 120, designed to allow the CPU 220 to control sub-blocks 160 without impacting data transfer on the data bus 110. In an embodiment, the control bus 120 is a switcher-based bus with 32-bit data and 32-bit address working at 133 MHz or the same frequency of Video CODEC.

Data at various stages of processing may be stored in programmable direct memory access (DMA) memory 140. Data coming to or from DRAM 200 or the CPU 220 over the system bus 150, for instance, can be temporarily stored in the DMA 140. In an embodiment, the system bus 150 comprises an advanced high performance bus (AHB), and the CPU comprises an Xtensa processor designed by Tensilica of Santa Clara, Calif. In an embodiment, the DMA 140 is composed of at least two parts—a configurable cache and programmable DMA. The configurable cache stores data that could be used by sub-blocks and acts as a write-back buffer to store data from sub-blocks before writing to DRAM 200 through the system bus 150. Combined with Programmable DMA, which could preload data into cache from DRAM through the system bus 150 by performing commands sent from the CPU 220, encoding and decoding processes are less dependent on traffic conditions on the system bus 150. The programmable DMA 140 accepts requests from the control bus 120. After translating the request, DMA transfer will be launched to read data from the system bus 150 into a local RAM pool or write data to the system bus 150 from a local RAM pool. The configurable cache consists of video memory management & data switcher (VMDDS) and RAM pool. The VMMDS is a bridge between the RAM pool and other sub-blocks that read data from cache or write data to cache. It receives requests from sub-blocks and finds routes to corresponding RAM through a predefined memory-mapping algorithm. In an embodiment, the cache memory comprises four RAM segments. Their sizes might be different. As these RAMs could be very large (2.5M-bits) and only one-port memory is preferable, additional mechanisms may be introduced to solve read-write competition problems.

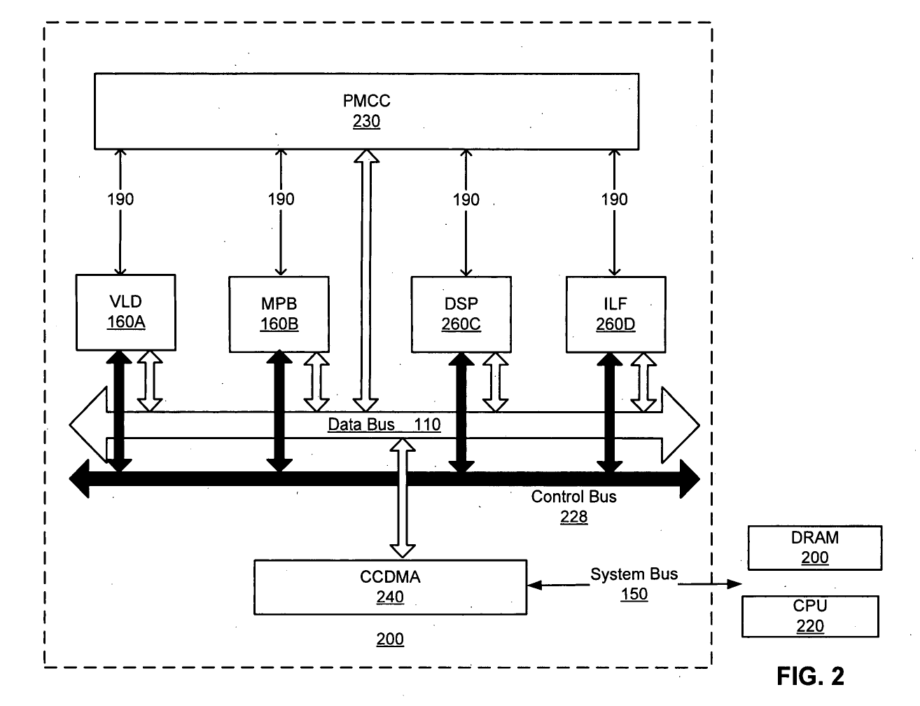

FIG. 2 depicts a block diagram of an exemplary processing architecture for a decoder processing system in accordance with an embodiment of the invention. As shown, the system 280 relies on the basic system architecture 100 depicted in FIG. 1 but includes several processing modules 260 to support video compression in accordance with the MPEG-4 standard. As shown, the system 280 includes a programmable memory copy controller (PMCC) 230, configurable cache DMA 240, coupled to various processing modules 260 via a data bus 210 and control bus 220. The processing modules include a variable length decoder 260a, motion prediction block 260b, digital signal processor 260c, and in-loop filter 260d. In an embodiment, each of the modules 260 is implemented in hardware, enhancing the efficiency of the system design. Although FIG. 2 depicts a decoder system, some or all the elements shown could be included in a CODEC or other processing system.

The variable length decoder (VLD) 260a and digital signal processor (DSP) 260c comprise video processing modules configured to support processing according to a video compression/decompression standard. The VLD 260a generates macroblock-level data based on parsed bit-streams to be used by the other modules. The DSP 260c comprises a specialized data processor with a very long instruction word (VLIW) instruction set. In an embodiment, the DSP 260c can process eight parallel calculations in one instruction and is configured to support motion compensation, discrete cosine transform (DCT), quantizing, de-quantizing, inverse DCT, motion de-compensation and Hadamard transform calculations.

The motion prediction block 260b is used to implement motion search & data prediction. In an embodiment, the motion prediction blovk is designed to support Q-Search and motion vector refinement up to quarter-pixel accuracy. For H.264 encoding, 16×16 mode and 8×8 mode motion prediction are also supported by this block. In a decoder/encoder system, output from the MPB 260b is provided to the processing modules 260a, 260c for generation of a video elementary stream (VES) for encoding or reconstructed data for decoding. The motion prediction block 260b may be supplemented by other motion prediction and estimation blocks. For instance, a fractal interpolation block (FIB) can be included to support fractal interpolated macro block data, or a direct and intra block may be used to support prediction for a direct/copy mode and make decisions of intra prediction modes for H.264 encoding. In an embodiment, the motion prediction block 260b, and one or more supporting blocks are combined together and joined through local connections before being integrated into a CODEC platform. Data transfer between the MPB 260b, FIB, and other blocks takes place over these local connections, rather than over a data or system bus. In addition, in an embodiment, there are local read/write connections between the ILF 260d and CCD 280 and the FIB and CCD 280 to facilitate rapid data transfer.

Additional data processing is carried out by the in-loop filter (ILF) 260d. The ILF 260d is designed to perform filtering for reconstructed macro block data and write the back the result to DRAM 200 through CCD. This block also separates frames into fields (top and bottom) and writes these fields into DRAM 220 through CCD 240. In an encoder implementation of the invention, a temporal processing block (TPB) is included (not shown)—that supports temporal processing such as de-interlacing, temporal filtering, and Telecine pattern detection (and inverse Telecine) for the frame to be encoded. Such a block could be used for pre-processing before the encoding process takes place.

Decoding

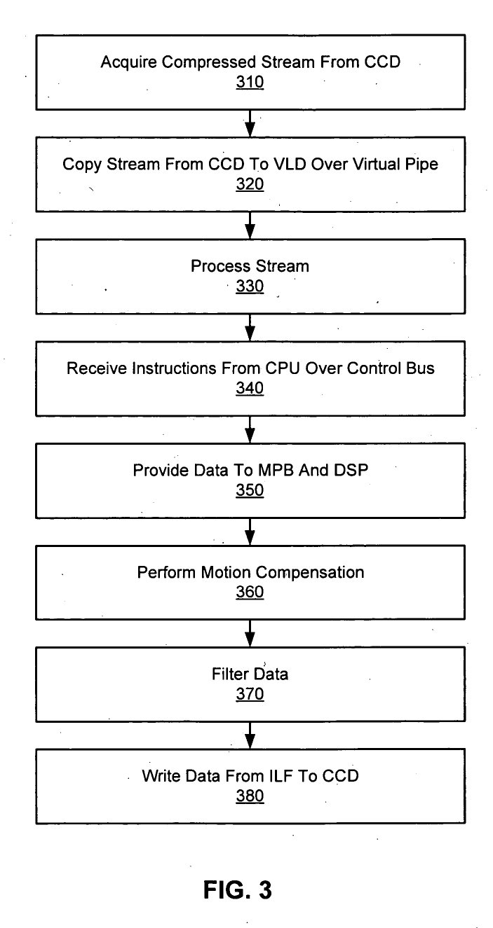

In an embodiment, the system of FIG. 2 is used to carry out decoding in accordance with the MPEG4 standard. This process is outlined at a high level in FIG. 3. The decoding process begins with the acquisition 310 of a compressed stream from a memory, for instance double data rate SDRAM (DDR). In an embodiment, there are at least two methods by which CCD 280 can fetch the data from DDR—by using a region-based pre-fetch method and a linear-based pre-fetch method. In a region-based pre-fetch, the CCD 280 sends a command to the bit stream to be decoded. In a linear-based pre-fetch, the position and size of the stream are specified and used to acquire the bit stream to be decoded. In a region-based pre-fetch, the CCD 280 sends a command which specifies the stream according to the reference frame number and region of the data. The CCD 280 returns the information, which is then written to an internal buffer.

After the stream has been delivered from DDR to the CCD 280, a producer request is sent by the CCD 280 to the PMCC 230 indicating that the CCD 280 is ready to give, and a receiver request is sent by the VLD 260A to the PMCC 230 indicating that the VLD 260A is ready to receive. The PMCC 230 creates a virtual pipe between the CCD 280 and VLD 260A and copies 320 the stream to be decoded to VLD 260A over the data bus 210. The VLD 260A receives the stream in compressed form and processes 330 it at the picture/slice boundary level, receiving instructions as needed from the CPU 220 over the control bus 220 340. The VLD 260A expands the stream, generating syntax and data for each macroblock. The data comprises motion vector, residue, and additional processing data for each macroblock. The motion vector and processing data is provided 350 to the motion prediction block (MPB) 260B and the residue data provided 350 to the DSP 260C. The MPB 260B processes the macroblock level data and returns reference data that will be used to generate the decompressed stream to the DSP 260C.

The DSP 260C performs motion compensation 360 using the residue and reference data. The DSP 260C performs inverse DCT on the residue, adds it to the reference data and uses the result to generate raw video data. The raw data is passed to the in-loop filter 260D, which takes the data originally generated by the VLD 260A to filter 370 the raw data to produce the uncompressed video stream. The final product is written from the ILF to the CCD over a local connection. During the processes described above, macroblock level copying transactions are carried almost entirely over the data bus 210. However, at higher levels, for instance, the picture/slice boundary, the CPU sends controls over the control bus 225 to carry out processing.

Encoding

Encoding may also be carried out using a system similar to that shown in FIG. 2, except that encoding functionalities are supported by the modules 260, and a variable length encoder (VLC) is included. Using the architecture described herein, the encoding process uses the data bus to complete data transfers carried out in the course of encoding. The MPB 260b takes an uncompressed video stream and does a motion search according to any of a variety of standard algorithms. The MPB 260b generates vectors, original data, and reference data based on the video stream. The original and reference data are provided to the DSP 260c, which uses it to generate residues. The residues are transformed and quantized, resulting in quantized transform residues representing the video stream. These steps are carried out in accordance with a standard such as MPEG-4, which specifies the use of a Hadamard or DCT-based transform, although other types of processing may also be carried out. The quantized transform residues are dequantized and an inverse transform is performed using the reference data to generate reconstructed data for each frame.

The reconstructed data are added to the residue are provided to the ILF 260d, which filters the data. In accordance with the H.264 standard, the ILF 260d removes unwanted processing artifacts and uses a filter, such as a content adaptive non-linear filter, to modify the stream. The ILF 260d writes the resulting processed stream to CCD 280 in order to create reference data for later use by the MPB 260b. The quantized transform residues and the quantized transform data are provided to the VLC. Vector and motion information are also provided from the MPB 260b to the VLC. The VLC takes this data, compresses it according to the relevant specification, and generates a bitstream that is provided to the CCD 280.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A video processing system, the system comprising:
a plurality of processing modules including a first processing module and a second processing module;
a data bus coupling each of the first processing module and second processing module to a copy controller, the copy controller configured to facilitate the transfer of data between the first processing module and the second processing module over the data bus; and
a control bus coupling a processor and a processing module of the plurality of processing modules and configured to provide control signals from the processor to the processing module of the plurality of processing modules.

2. The system of claim 1, further comprising a semaphore module for mediating communication between at least two of: the first processing module, the second processing module, the copy controller, and the processor.

3. The system of claim 2, wherein the semaphore comprises an array of semaphore units, each unit configured to store data that can be modified by at least one of a first processing mode and a second processing mode.

4. The system of claim 1, further comprising a direct memory access module coupled to the data bus and configured to temporarily store a video stream to be processed by the video processing system.

5. The system of claim 4, wherein the direct memory access module comprises configurable cache direct memory access memory (CCDMA).

6. The system of claim 1, wherein the copy controller comprises a programmable memory copy controller.

7. The system of claim 1, implemented in a system on chip.

8. The system of claim 7, wherein the processor is included in the system on chip.

9. The system of claim 7, wherein the processor comprises an off-chip processor.

10. The system of claim 1, wherein the plurality of video processing modules includes at least one of: a variable length decoder, a motion prediction block, an in-loop filter, a fractal interpolation block, a direct and intra block, and a temporal processing block.

11. The system of claim 1, configured to implement video processing according to a H.264 protocol.

12. The system of claim 4 further comprising a local connection between one of the plurality of video processing modules and the direct memory access module for transfer of data therebetween.

13. A method of decoding a video stream, the method comprising:
receiving the video stream;
copying the stream to a video processing module over a data bus;
receiving instructions to process the stream over a control bus;
processing the stream; and
providing the processed stream to a memory over a local connection.

14. The method of claim 13, wherein the step of processing the stream is performed by at least one of: a variable length decoder, a motion prediction block, an in-loop filter, a fractal interpolation block, a direct and intra block, and a temporal processing block.

15. The method of claim 13, wherein step of copying further comprises receiving by a copy controller a producer request to produce the video stream and a consumer request to receive the video stream and wherein the step of copying is carried out responsive to the producer request and the consumer request.

16. The method of claim 15, wherein the step of copying further comprises copying over a virtual pipe to the video processing module created by the copy controller.

17. The method of claim 13, wherein the step of copying is carried out responsive to a semaphore status signal.

18. The method of claim 13, carried out by a system on chip wherein the step of receiving comprises receiving the instructions generated by an off-chip processor.

19. A video decoder, the video decoder comprising:
a plurality of processing modules including a variable length decoder, a motion prediction block, an in-loop filter, a fractal interpolation block, a direct and intra block, and a temporal processing bloc;
a data bus coupling each of the first processing module and second processing module to a programmable memory copy controller (PMCC), the PMCC configured to facilitate the transfer of data between a first processing module and a second processing module over the data bus; and
a control bus coupling a central processing unit and a processing module of the plurality of processing modules and configured to provide control signals from the central processing unit to the processing module of the plurality of processing modules.
